(19) United States
(12) Patent Application Publication
(10) Pub. No.: US 2021/0005363 A1
(43) Pub. Date: Jan. 7, 2021

(54) SURGE ARRESTER AND METHOD FOR INSTALLING A SURGE ARRESTER

(71) Applicant: SIEMENS AKTIENGESELLSCHAFT, MUENCHEN (DE)

(72) Inventor: ERHARD PIPPERT, DALLGOW-DOEBERITZ OT SEEBURG (DE)

(21) Appl. No.: 16/980,580

(22) PCT Filed: Mar. 6, 2019
(86) PCT No.: PCT/EP2019/055544

§ 371 Date: Sep. 14, 2020

(30) Foreign Application Priority Data
Mar. 14, 2018 (DE) 10 2018 203 893.7

(51) Int. Cl. H01C 7/12; H01C 1/02; H01C 17/00

(52) U.S. Cl. CPC H01C 7/12; H01C 17/00; H01C 1/02

(57) ABSTRACT

A surge arrester includes a tubular housing and an end fitting which is connected to one end of the housing and on which a column having at least one electrical resistor is disposed. A support abuts the inner surface of the tubular housing in the region of the end fitting. The support has a recess in the longitudinal direction of the surge arrester, into which a pressure device is inserted. A method for installing a surge arrester is also provided.

The invention relates to a surge arrester according to the precharacterizing clause of claim 1 and a method for installing a surge arrester according to claim 9.

Surge arresters are used in the medium voltage and high voltage range in order to divert so-called surge voltages, i.e. voltages well above the nominal voltages provided during operation, safely to ground. This prevents damage to operating means such as transformers, for example. By way of example, a surge arrester for high voltage can be arranged on an overhead line and divert impermissibly high currents to ground in the event of a lightning strike or short circuit.

Surge arresters generally contain so-called variable resistors, i.e. electrical resistors, whereof the electrical resistance value is very high up to a design-dependent threshold voltage and is significantly reduced above the threshold voltage so that the surge arrester becomes a good electrical conductor. These resistors are therefore frequently referred to as so-called “variable resistors”. Metal oxide resistors, for example, in disc form are arranged above one another in a housing and connected to the high voltage potential and ground potential at the respective ends of the housing. In this case, the surge arrester is barely conductive in normal operation, so that only a slight leakage current flows to ground. However, a high stray current flows in the event of a fault.

A generic surge arrester is known from document DE 102011088072 A1, in which a tubular housing is configured to be comparatively resistant to bending by way of a support device. The support device has at least one clamping ring, which abuts internally against the housing and is conically formed on the side remote from the housing. A support ring equipped with a matching mating cone is seated on this cone. By displacing the support ring in the longitudinal direction of the tubular housing, a force is transmitted via the two cones to the inner surface of the tubular housing, which is thus mechanically stabilized. For a form-locking engagement between the tubular housing, support ring and adjusting rings, precise matching of the components is advantageous.

Starting with the known support device, the object of the invention is to provide a support device which provides an improved bending strength for the tubular housing with comparatively high manufacturing tolerances.

The invention achieves this object by a surge arrester according to claim 1.

The surge arrester according to the invention has the advantage that the support means has, in the longitudinal direction of the surge arrester, a recess which, for example, cuts through the support means completely. By way of example, the support means is, however, formed as an individual hollow cylinder segment or ring segment. If a pressure means is inserted into this recess, a good pressing effect can still be achieved, even with comparatively large deviations of the internal diameter of the tubular housing from the given value. In comparison with the previous method, greater manufacturing tolerances can be compensated, which enables the tubular housing to be produced more cost-effectively than before.

In a preferred embodiment of the inventive surge arrester, the pressure means is formed to be substantially wedge-shaped. This is an advantage since, owing to the insertion depth of the pressure means in the support means, a clamping seat is thus always achieved between the pressure means and the support means on the one hand and the support means and the tubular housing on the other.

In a further preferred embodiment of the inventive surge arrester, the pressure means is arranged in the recess substantially with form locking. This further development has the advantage that the clamping seat between the pressure means and the support means on the one hand and the support means and the tubular housing on the other is realized with form locking. As a result, the mechanical stability of the tubular housing, in particular the bending strength at the end fittings, is reinforced in a manner which is comparatively particularly effective.

In a further preferred embodiment of the inventive surge arrester, the recess has two contact regions with the pressure means, wherein the contact regions each have a guide groove and wherein the pressure means has a respective guide projection on its sides facing the contact regions of the support means, and wherein the guide projections are arranged in the guide grooves. This is an advantage since the pressure means cannot slip out of the support means in the transverse direction of the surge arrester. By way of example, the guide groove can have a triangular or quadrangular cross-section. It is particularly preferred if the guide grooves have a parabolic form. The guide projections in this case are formed in a particularly complementary manner to the guide grooves.

In a further preferred embodiment of the inventive surge arrester, the guide grooves and the guide projections fix the pressure means on the support means in such a way that a substantially cylinder-barrel-shaped outer contour of the pressure means and support means is produced, which is pressed against the inner surface of the tubular housing without damage. This an advantage since simple and secure installation is ensured.

In a further preferred embodiment of the inventive surge arrester, the support means is formed substantially as a hollow cylinder.

In a further preferred embodiment of the inventive surge arrester, the support means has a plurality of hollow cylinder segments, which, in the installed state, form a plurality of recesses for receiving a plurality of pressure means. By way of example, 3 or 4 segments and correspondingly 3 or 4 pressure means can be used. This is advantageous since the hollow cylinder segments in conjunction with the pressure means permit simple and particularly precise adaptation of the support means to the internal diameter of the tubular housing.

In a further preferred embodiment of the inventive surge arrester, the support means forms a ring-shaped step in which the column is received substantially with form locking.

Starting with the known method for installing surge arresters, the object of the invention is to provide a method for installing a surge arrester, which, with relatively high manufacturing tolerances for the tubular housing, enables an improved bending strength.

The invention achieves this object by a method for installing surge arresters according to claim 9. Preferred embodiments of the inventive method are described in claims 10 to 15. In this case, the same advantages as explained at the outset for the inventive surge arrester are realized analogously for the inventive method and its embodiments.

To better explain the invention, preferred embodiments are shown in a schematic illustration in the figures, which show:

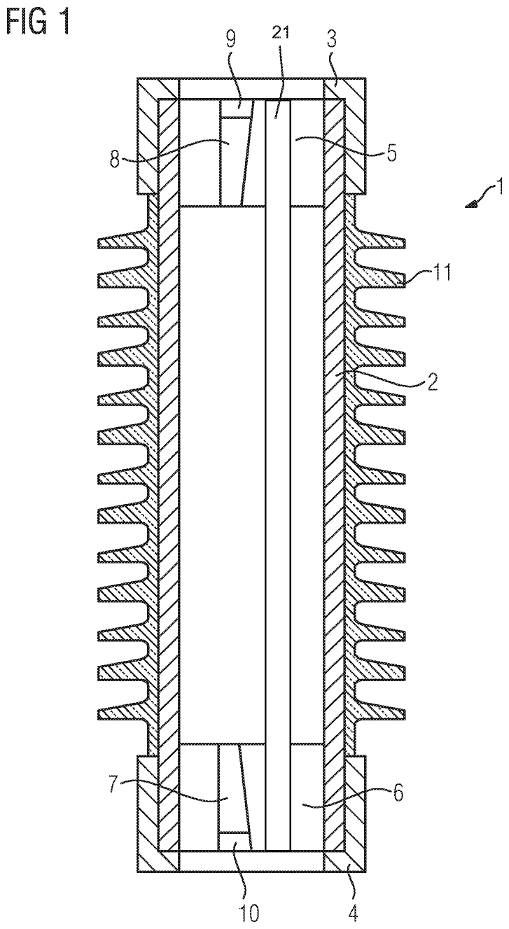

FIG. 1 a first embodiment of an inventive surge arrester, and

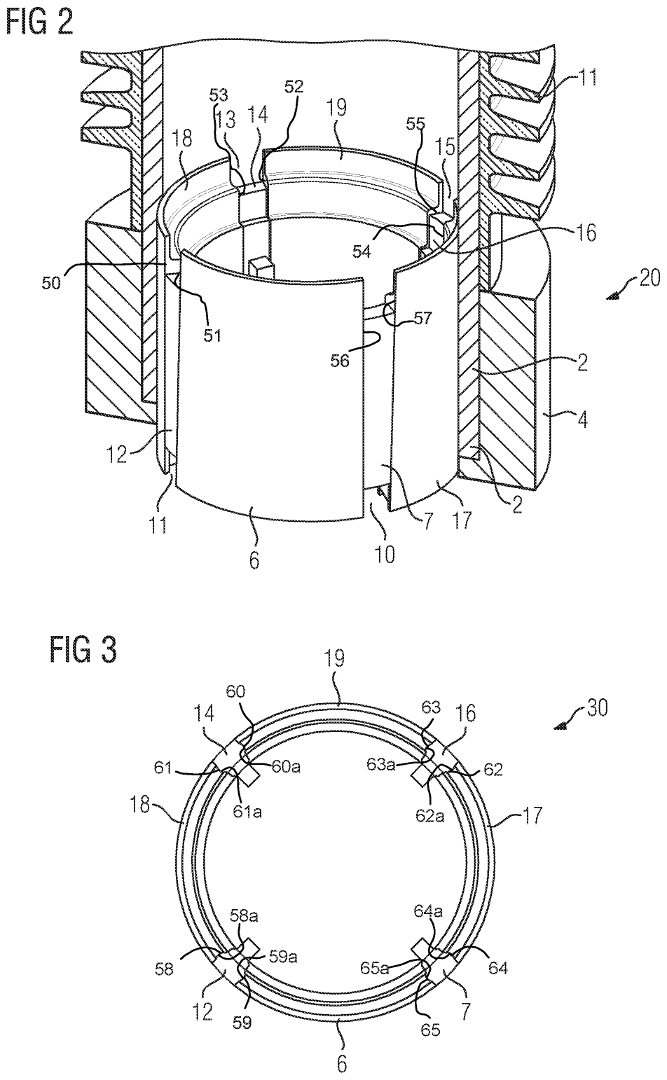

FIG. 2 a first detailed view of a second embodiment of an inventive surge arrester, and

FIG. 3 a cross-section of the second embodiment according to FIG. 2, and

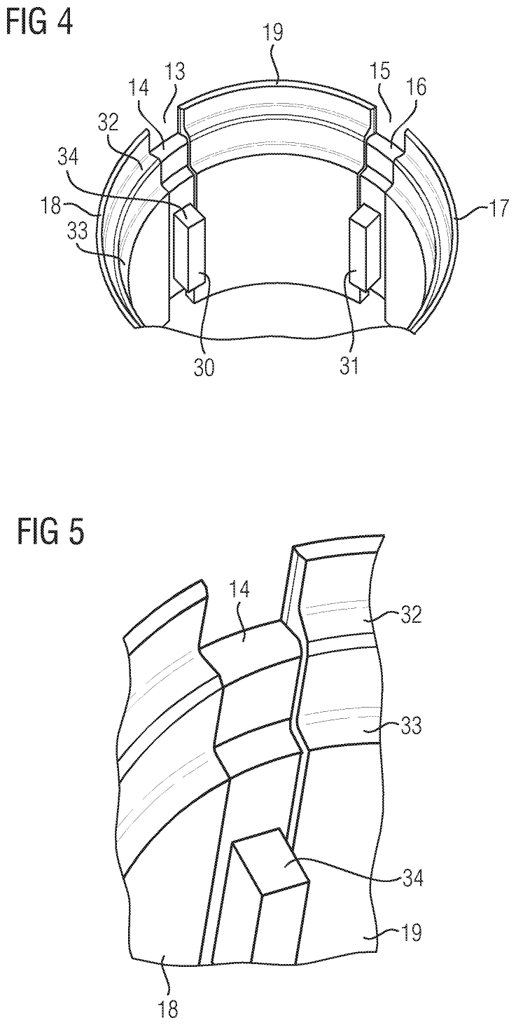

FIG. 4 a second detailed view of the second embodiment according to FIG. 2, and

FIG. 5 a third detailed view of the second embodiment according to FIG. 2.

FIG. 1 shows a first embodiment of an inventive surge arrester 1. The surge arrester 1 has a tubular housing 2 which is adjoined by respective end fittings 3, 4 in the longitudinal direction of the arrester 1. The tubular housing 2 is equipped with an insulation layer 11 of silicone between the end fittings 3, 4. Alternatively, another material, such as ethylene propylene diene M-class rubber (EPDM), for example, can also be used for the insulation layer 11. The insulation layer 11 has shields for extending the creepage path between the end fittings 3, 4. Support means 5, 6 are provided to improve the bending strength of the tubular housing 2 at the end regions. The support means are formed as hollow cylinders with recesses 9, 10. The recesses 9, 10 are formed in a wedge shape. Wedge-shaped pressure means 7, 8 are inserted in the wedge-shaped recesses 9, 10. By displacing the wedge-shaped pressure means 7, 8 in the longitudinal direction of the tubular housing within the recesses 9, 10, the support means 5, 6 can be spread apart and thereby pressed against the inner surface of the tubular housing. This pressing action brings about a reinforcement of the housing in the region of the end fittings and therefore an increased bending strength in this region. In this example, the wedge-shaped recesses are created in such a way that they face the respective end fitting 3, 4 with their wider end.

FIG. 2 shows a first detailed view 20 of a second embodiment of the inventive surge arrester. The support means in this embodiment is formed by four hollow cylinder segments 6, 17, 18, 19, which form wedge-shaped recesses 10, 11, 13, 15. Wedge-shaped pressure means 7, 12, 13, 16 are inserted into these wedge-shaped recesses 10, 11, 13, 15 with form locking and bring about a pressing action against the tubular housing 2. In this case, the wedge-shaped recesses in this embodiment face the end fittings 3, 4 with their narrower end.

FIG. 3 shows a cross-section 30 of the embodiment 20 according to FIG. 2. The hollow cylinder segments 6, 17, 18, 19 each form two contact regions 50-57 with the pressure means 7, 12, 14, 16 in their recesses. These contact regions 50-57 each have a guide groove 58-65, which is formed to be parabolically rounded in this example. The parabolic form is simple to manufacture and offers good slip resistance. The pressure means 7, 12, 14, 16 each have, at their sides facing the contact regions 50-57, a guide projection which is arranged in the respective guide groove 58-65. The interaction between the guide grooves and guide projections means that the pressure means cannot slip out of the hollow cylinder segments in the transverse direction. The pressure means and the hollow cylinder segments form a substantially cylinder-barrel-shaped outer contour of the pressure means and support means, which can be pressed against the inner surface of the tubular housing without damage.

FIGS. 4 and 5 shows a second and a third detailed view of the second embodiment. In this case, it can be seen that the hollow cylinder segments 17, 18, 19 and also the pressure means 14, 16 are created in such a way that they form two steps 32, 33 extending in the shape of a ring. It can furthermore be seen that the pressure means 14, 16 have projections 30, 31. These projections 30, 31 form a further step 34, which serves as a bearing surface for a column with variable resistors. In this case, the bearing surface 34 is consequently formed by the projections 30, 31.

1-15. (canceled)

16. A surge arrester, comprising:
a tubular housing having an end and an inner surface;
an end fitting connected to said end of said housing;
a column disposed on said end fitting, said column having at least one electrical resistor;
a support abutting said inner surface of said tubular housing in a region of said end fitting, said support having a recess formed in a longitudinal direction of the surge arrester; and
a pressure device inserted in said recess.

17. The surge arrester, according to claim 16, wherein said pressure device is wedge-shaped.

18. The surge arrester according to claim 16, wherein said pressure device is form-lockingly disposed in said recess.

19. The surge arrester according to claim 16, wherein:
said recess has two contact regions contacting said pressure device;
said contact regions each have a guide groove;
said pressure device has sides facing said contact regions and a respective guide projection on each of said sides; and
said guide projections are disposed in said guide grooves.

20. The surge arrester according to claim 19, wherein said guide grooves and said guide projections fix said pressure device on said support and produce a cylinder-barrel-shaped outer contour of said pressure device and said support being pressed against said inner surface of said tubular housing without damage.

21. The surge arrester according to claim 16, wherein said support is a hollow cylinder.

22. The surge arrester according to claim 16, wherein said pressure device is one of a plurality of pressure devices, said recess is one of a plurality of recesses, and said support has a plurality of hollow cylinder segments forming said plurality of recesses for receiving said plurality of pressure devices in an installed state.

23. The surge arrester according to claim 16, wherein said support forms a ring-shaped step in which said column is form-lockingly received.

24. A method for installing a surge arrester, the method comprising:
placing a support on an inner surface of a tubular housing; and
inserting a pressure device into a recess formed in the support in an insertion direction extending in a longitudinal direction of the tubular housing.

25. The method according to claim 24, which further comprises using a wedge-shaped pressure device as the pressure device.

26. The method according to claim 24, which further comprises placing the pressure device form-lockingly in the recess.

27. The method according to claim 24, which further comprises:
providing the support with two contact regions contacting the pressure device;
providing each of the contact regions with a guide groove;
providing the pressure device with respective guide projections on sides facing the contact regions of the support; and
inserting the guide projections into the guide grooves.

28. The method according to claim 24, which further comprises using the guide grooves and the guide projections to fix the pressure device on the support and produce a cylinder-barrel-shaped outer contour of the pressure device and the support being pressed against the inner surface of the tubular housing without damage.

29. The method according to claim 24, which further comprises providing the support with a plurality of hollow cylinder segments forming a plurality of recesses for receiving a plurality of pressure devices in an installed state.

30. The method according to claim 24, which further comprises using the support to form a ring-shaped step in which a column having at least one electrical resistor is form-lockingly received.
